(19) United States
(12) Patent Application Publication
(10) Pub. No.: US 2026/0371294 A1
(43) Pub. Date: Nov. 19, 2026

(54) MITIGATION OF POSITIONING MEASUREMENT IMPACT ON RLF PROCEDURE

(71) Applicant: NOKIA TECHNOLOGIES OY, Espoo (FI)

(72) Inventors: Mads LAURIDSEN, Gistrup (DK); Ping YUAN, Beijing (CN); Jing Yuan SUN, Beijing (CN)

(21) Appl. No.: 19/154,467

(22) PCT Filed: Feb. 10, 2023
(86) PCT No.: PCT/CN2023/075398

§ 371 Date: Aug. 7, 2025

(51) Int. Cl. H04W 64/00; H04W 24/08; H04W 74/0833; H04W 84/06

(52) U.S. Cl. CPC H04W 64/00; H04W 24/08; H04W 74/085; H04W 84/06

(57) ABSTRACT

Example embodiments of the present disclosure relate to apparatuses, methods, and computer readable storage medium for mitigation of positioning measurement impact on a radio link failure (RLF) procedure. In a method, an apparatus performs a RLF process and performs a positioning measurement process. At least one of the RLF process or the positioning measurement process is adjusted to mitigate collision between the processes.

### FIELDS

Various example embodiments of the present disclosure generally relate to the field of telecommunication and in particular, to apparatuses, methods, and computer readable storage medium for mitigation of positioning measurement impact on a radio link failure (RLF) procedure.

### BACKGROUND

Internet of Things (IoT) over non-terrestrial network (NTN) is supported in the third-generation partnership project (3GPP) Release 18 (Rel-18). In enhancements related to mobility and performance in Rel-18, an assumption is that simultaneous operations related to both a Global Navigation Satellite System (GNSS) and NTN Narrow Band (NB)-IoT/enhanced Machine-Type Communication (eMTC) may not be possible.

For GNSS measurements, an evolved NodeB (eNB) may aperiodically schedule GNSS measurement gaps, such that user equipment (UE) may obtain a new GNSS position fix before an expiry of the validity of the current GNSS position. However, the eNB may not know that the UE is experiencing link problems, because those may not reported by the UE unless specifically configured by the eNB. Therefore, it may happen that the UE has a scheduled GNSS measurement gap, which may coincide with a RLF procedure.

### SUMMARY

In a first aspect of the present disclosure, there is provided an apparatus. The apparatus comprises at least one processor; and at least one memory storing instructions that, when executed by the at least one processor, cause the apparatus at least to perform: performing a radio link failure process; and performing a positioning measurement process, wherein at least one of the radio link failure process or the positioning measurement process is adjusted to mitigate collision between the radio link failure process and the positioning measurement process.

In a second aspect of the present disclosure, there is provided an apparatus. The apparatus comprises at least one processor; and at least one memory storing instructions that, when executed by the at least one processor, cause the apparatus at least to perform: receiving, from a further apparatus, a first radio link monitoring report for an early-out-of-synchronization event, or a second radio link monitoring report for an early-in-synchronization event, the early-out-of-synchronization event and the early-in-synchronization event being associated with a radio link failure process performed by the further apparatus; and transmitting, to the further apparatus, a configuration for a shifting time of a measurement gap for a positioning measurement process to be performed by the further apparatus, to mitigate collision between the radio link failure process and the positioning measurement process.

In a third aspect of the present disclosure, there is provided a method. The method comprises: performing a radio link failure process; and performing a positioning measurement process, wherein at least one of the radio link failure process or the positioning measurement process is adjusted to mitigate collision between the radio link failure process and the positioning measurement process.

In a fourth aspect of the present disclosure, there is provided a method. The method comprises: at an apparatus, receiving, from a further apparatus, a first radio link monitoring report for an early-out-of-synchronization event, or a second radio link monitoring report for an early-in-synchronization event, the early-out-of-synchronization event and the early-in-synchronization event being associated with a radio link failure process performed by the further apparatus; and transmitting, to the further apparatus, a configuration for a shifting time of a measurement gap for a positioning measurement process to be performed by the further apparatus, to mitigate collision between the radio link failure process and the positioning measurement process.

In a fifth aspect of the present disclosure, there is provided an apparatus. The apparatus comprises means for performing a radio link failure process; and means for performing a positioning measurement process, wherein at least one of the radio link failure process or the positioning measurement process is adjusted to mitigate collision between the radio link failure process and the positioning measurement process.

In a sixth aspect of the present disclosure, there is provided an apparatus. The apparatus comprises means for receiving, from a further apparatus, a first radio link monitoring report for an early-out-of-synchronization event, or a second radio link monitoring report for an early-in-synchronization event, the early-out-of-synchronization event and the early-in-synchronization event being associated with a radio link failure process performed by the further apparatus; and means for transmitting, to the further apparatus, a configuration for a shifting time of a measurement gap for a positioning measurement process to be performed by the further apparatus, to mitigate collision between the radio link failure process and the positioning measurement process.

In a seventh aspect of the present disclosure, there is provided a computer readable medium. The computer readable medium comprises instructions stored thereon for causing an apparatus to perform at least the method according to the third or fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2A illustrates a diagram of an example RLF procedure according to some example embodiments;

FIG. 2B illustrates a diagram of an example scenario where a GNSS measurement is performed during an RLF procedure according to some example embodiments of the present disclosure;

FIG. 3 illustrates a flowchart of a method according to some example embodiments of the present disclosure;

FIG. 4 illustrates a flow chart of an example process to adjust the RLF process according to some example embodiments of the present disclosure;

FIG. 5 illustrates a flowchart of an example process for adjusting a measurement gap in accordance with some example embodiments of the present disclosure;

FIG. 6 illustrates a flowchart of an example process for adjusting a measurement gap in accordance with some other example embodiments of the present disclosure;

FIG. 7 illustrates a simplified block diagram of an apparatus that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure.

It is noted that example embodiments of the present disclosure are equally applicable to other resources in other domains.

Radio link related measurements may be required for Radio Link Monitoring (RLM), which may be used to estimate whether the UE may reliably receive and decode a physical downlink control channel (PDCCH). In RLM, the UE may detect physical layer problems in a radio resource control (RRC)_CONNECTED mode. For example, upon receiving a predetermined or network configured number of (for example, N310) consecutive out-of-synchronization (or “out-of-sync”) (OoS) indications for a source primary cell (PCell) from lower layers, the UE may start a timer such as T310. For recovery of physical layer problems, the UE may detect in-synchronization (or “in-sync”) (IS) indications for the PCell. Upon receiving a predetermined or network configured number (for example, N311) of consecutive “in-sync” indications for the PCell from lower layers while the timer such as T310 is running, the UE may stop the timer. In this case, the UE may maintain a RRC connection without explicit signalling, that is, the UE may maintain an entire radio resource configuration. Periods in time where neither “in-sync” nor “out-of-sync” is reported by layer 1 may not affect the evaluation of the number of consecutive “in-sync” or “out-of-sync” indications.

Based on the release 17 (Rel-17) specification, user equipment (UE) may utilize the GNSS operation to pre-compensate any uplink transmission towards a satellite to ensure time and frequency alignment. As described above, IoT over NTN is supported in 3GPP Rel-18. However, in enhancements related to mobility and performance in Rel-18, an assumption is that simultaneous operations related to both a GNSS and NTN NB-IoT/eMTC may not be possible. The eNB may therefore schedule a “GNSS measurement gap”, where the UE may utilize the GNSS to obtain a new position fix, but where the UE may not be able to operate the NB-IoT/eMTC during the gap.

There may be a situation where the UE has a scheduled GNSS measurement gap, which coincides with a radio link failure (RLF) procedure. For example, if the UE has determined N310 OoS counts, the UE may start the T310 timer. Shortly after starting the T310, the UE may perform a GNSS measurement and thus the UE may be unable to detect IS indications and thus may declare the RLF. This is problematic, because it would trigger a RRC Connection Re-establishment procedure, which may make the UE unavailable for further, immediate communication with the eNB. In some cases, the UE might have recovered from the RLF if it was not performing the GNSS measurement and thus the RLF procedure and the RRC Connection Re-establishment procedure could have been avoided.

Always configuring a longer T310 (for example, longer than the GNSS measurement of the UE) may not be a useful option, because at any other point in time during the connection it may be desirable to quickly detect radio link problems.

Example embodiments of the present disclosure propose a scheme to handle interruptions of a RLF procedure by GNSS measurements. With the scheme, at least one of a RLF process or a positioning measurement process (such as a GNSS measurement process) performed by an apparatus such as a UE is adjusted to mitigate collision between the two processes. In the context of the present disclosure, a RLF process and a positioning measurement process may also be referred to as a RLF procedure and a positioning measurement procedure, respectively. In some example embodiment, some new UE behaviors may be defined if the RLF procedure and GNSS measurements (for NTN, for example) might collide. For example, the UE may extend or pause the T310 timer if it may collide with a GNSS measurement gap. Detailed behaviors may be discussed in the following paragraphs.

In this way, it may be avoided for a UE to declare a fake or false RLF during the GNSS measurement due to a failure of IS evaluation during the GNSS measurement. Such declaration may result in the following RRC Connection Reestablishment, which may cause larger power consumption and signaling overhead. The scheme according to example embodiments of the present disclosure may save UE energy and minimize signaling, which is more efficient.

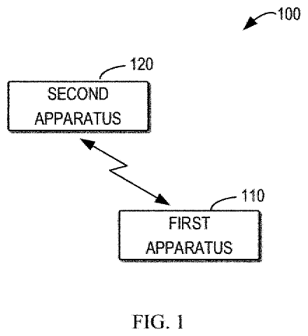

FIG. 1 illustrates an example communication environment 100 in which example embodiments of the present disclosure can be implemented. In the communication environment 100, a plurality of communication devices, including a first apparatus 110 and a second apparatus 120, can communicate with each other.

In the following, for the purpose of illustration, some example embodiments are described with the first apparatus 110 operating as a terminal device such as a UE and the second apparatus 120 operating as a network device such as a gNB. However, in some example embodiments, operations described in connection with a terminal device may be implemented at a network device or other devices, and operations described in connection with a network device may be implemented at a terminal device or other devices.

In some example embodiments, if the first apparatus 110 is a terminal device and the second apparatus 120 is a network device, a link from the second apparatus 120 to the first apparatus 110 is referred to as a downlink (DL), while a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver). In some example embodiments, both the first and second apparatuses 110 and 120 may be terminal devices which can communicate with each other in Sidelink (SL).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of apparatuses are only for the purpose of illustration without suggesting any limitations. The communication environment 100 may include any suitable numbers of apparatuses for implementing embodiments of the present disclosure.

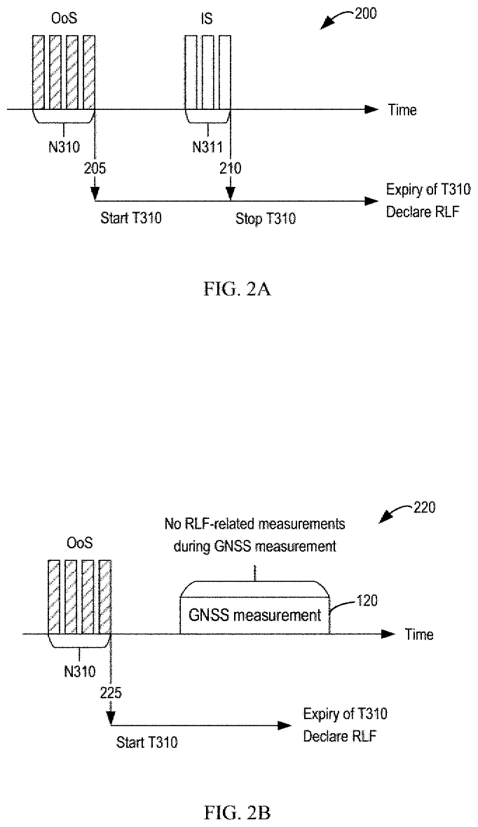

In the environment 100, the first apparatus 110 may perform a RLF process when needed. An example RLF process will be described with reference to FIG. 2A which shows an example RLF procedure 200 according to some example embodiments.

In the procedure 200, after the first apparatus 110 in a RRC Connected mode determines N310 (consecutive) OoS counts, the first apparatus 110 may start the T310 timer at a time 205. If N311 (consecutive) IS counts are determined when the T310 timer is running, the T310 timer may be stopped at a time 210 and return to the OoS counting. When the T310 timer is expired, the first apparatus 110 may declare the RLF. If the RRC Connection Re-establishment fails (for example, within a timer such as T311), the first apparatus 110 may move to a RRC Idle mode.

The following values for the counters and timers may be used for the RLF procedure 200:

RLF-TimersAndConstants-r9 ::=CHOICE {

| | |
|---|---|
| release | NULL, |
| setup | SEQUENCE { |
| t301-r9 | ENUMERATED {ms100, ms200, ms300, ms400, ms600, |

ms1000, ms1500, ms2000},

| | |
|---|---|
| t310-r9 | ENUMERATED {ms0, ms50, ms100, ms200, ms500, |

ms1000, ms2000},

| | |
|---|---|
| n310-r9 | ENUMERATED {n1, n2, n3, n4, n6, n8, n10, n20}, |
| t311-r9 | ENUMERATED {ms1000, ms3000, ms5000, ms10000, |

ms15000, ms20000, ms30000},

| | |
|---|---|
| n311-r9 | ENUMERATED {n1, n2, n3, n4, n5, n6, n8, n10}, |

```
    ...
  }
}
```

Moreover, the first apparatus 110 may perform a positioning measurement process, such as a GNSS measurement process, as configured or scheduled by a network, for example, via the second apparatus 120 such as an eNB. For example, the second apparatus 120 may aperiodically trigger the first apparatus 110 to make GNSS measurement, for example, via a media access control (MAC) control element (CE). Accordingly, the first apparatus 110 in a RRC connected mode may re-acquire GNSS position fix with a gap, as triggered by the second apparatus 120. In an example, the first apparatus 110 may report to the second apparatus 120 a GNSS position fix time duration for measurement during an initial access stage. In a connected mode, the first apparatus 110 may report to the second apparatus 120 a GNSS validation duration with a MAC CE. Based on such reporting, the second apparatus 120 may trigger the GNSS measurement of the first apparatus 110. Alternatively, or in addition, the first apparatus 110 may re-acquire GNSS autonomously (when configured by the network) if the first apparatus 110 does not receive a trigger to make GNSS measurement from the second apparatus 120.

During the GNSS measurement procedure, the first apparatus 110 may not be able to perform Radio Link Monitoring (RLM) for the RLF procedure, to estimate whether the first apparatus 110 may reliably receive and decode a PDCCH, as shown in FIG. 2B.

FIG. 2B shows an example scenario 220 where a GNSS measurement is performed during an RLF procedure according to some example embodiments of the present disclosure.

In the scenario 220, after the first apparatus 110 has determined N310 OoS counts and thus started the T310 timer at a time 225, the first apparatus 110 may perform a GNSS measurement 230. During this period, the first apparatus 110 may be unable to perform RLF-related measurement. For example, the first apparatus 110 may be unable to detect IS indications and have no chance counting IS before an expiry of T310.

In various example embodiments, the first apparatus 110 may adjust at least one of the RLF process or the positioning measurement process to mitigate collision between the two processes. For example, the first apparatus 110 may extend or pause the T310 timer, and/or shift or postpone a configured measurement gap, to avoid the interruption of the RLF process by the measurement process.

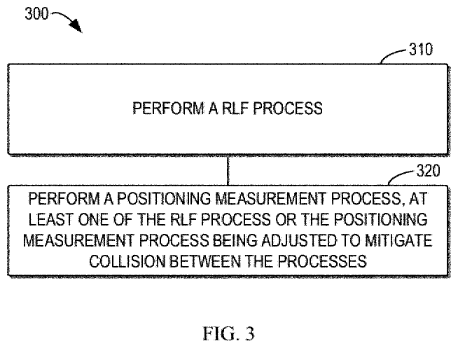

Some example embodiments of the present disclosure will be described in detail below with reference to FIGS. 3 to 6.

FIG. 3 shows a flowchart of an example method 300 in accordance with some example embodiments of the present disclosure. The method 300 may be implemented at either the first apparatus 110 or the second apparatus 120 as shown in FIG. 1. For the purpose of discussion, the method 300 will be described from the perspective of the first apparatus 110 in FIG. 1.

At block 310, the first apparatus 110 performs a RLF process. The RLF process may be performed when some conditions are fulfilled. For example, as shown in FIG. 2A, the first apparatus 110 may determine an OoS count and if the OoS count is equal to or greater than a threshold count (such as N310), the first apparatus 110 may start a timer such as T310.

At block 320, the first apparatus 110 performs a positioning measurement process such as an GNSS measurement process, for example, when needed. For example, the first apparatus 110 may be scheduled by the network, for example, via the second apparatus 120 such as a network device, to perform the positioning measurement process. Alternatively, or in addition, the first apparatus 110 may be configured by the network to autonomously perform the positioning measurement process.

According to example embodiments of the present disclosure, at least one of the two processes is adjusted by the first apparatus 110 if the two processes may be collided with each other. The RLF process and the positioning measurement process may be performed by the first apparatus 110 in any order. As an example, if the RLF process is postponed until the positioning measurement process is finished, the RLF process may be performed after the positioning measurement process. As another example, if the RLF process is paused before a start of the positioning measurement process and continued after completion of the positioning measurement process, the positioning measurement process may be performed during the entire RLF process. Alternatively, or in addition, if the positioning measurement process is shifted or postponed, the RLF process may be performed before the positioning measurement process.

The RLF process and/or the positioning measurement process may be adjusted in any suitable way to mitigate the collision therebetween. In some example embodiments, the RLF process may be adjusted if it may collide with the positioning measurement process. For example, if the first apparatus 110 determines that the positioning measurement process is imminent, the first apparatus 110 may determine a state of a timer such as T310 (such as shown in FIG. 3) for the RLF process and further make the corresponding adjustment.

The imminent positioning measurement process may be determined if the first apparatus 110 determines that a measurement gap used for the positioning measurement process is to start within a threshold time interval such as several seconds. The measurement gap may be scheduled by the network (for example, via the second apparatus 120) or to be triggered autonomously by the first apparatus 110. The threshold time interval may be network-configured or UE-implemented.

In some example embodiments, the first apparatus 110 may determine whether the timer is running or non-started. The running timer may mean that a predetermined number of (for example, N310) OoS may have been detected and IS may be evaluated.

That is, the RLF process is started. In this case, the first apparatus 110 may adjust the timer and thus perform the RLF process based on the adjusted timer to mitigate the collision between the RLF process and the imminent positioning measurement process.

The timer may be adjusted in any suitable way. In some example embodiments, the first apparatus 110 may pause the timer during the positioning measurement process. For example, the timer may be paused when or before the measurement gap starts and the remainder of the timer may be continued when the measurement is finished. In this way, the time duration of the timer may bypass the measurement gap, so as to avoid the collision between the RLF process and the positioning measurement process.

In some example embodiments, the first apparatus 110 may extend a value of the timer to cover a length of the measurement gap. For example, the timer may be extended when the measurement gap starts, such that the timer may not expire during the measurement gap, thereby avoiding the collision between the RLF process and the positioning measurement process. The extension value can be an absolute number, which may correspond to the duration of the measurement gap. Alternatively, or in addition, the extension value may be a multiplication factor. For example, the extended time length of the timer may be three or more times as long as a current time length of the timer, for example, 3×current T310.

The extension may be network-configured. For example, the timer may be extended based on a configuration (referred to as a “first configuration”) from a further apparatus (such as the second apparatus 120) which may be a network device or a terminal device, for an extension time (referred to as a “first extension time”) of the timer. Alternatively, or in addition, the extension may be UE implementation specific. For example, the first extension time of the timer may be set by the first apparatus 110 depending on the specific implementations.

The adjustment of the timer may cause the RLF process and the positioning measurement process to be staggered. The first apparatus 110 may continue to perform IS evaluation when the positioning measurement has finished according to the remainder of the timer.

In some example embodiments, the first apparatus 110 may adjust the timer by considering an IS count. For example, the first apparatus 110 may determine whether a condition that an IS count associated with the RLF process is equal to or greater than a threshold count (referred to as a “first threshold count”) and less than a further threshold count (referred to as a “second threshold count”) (such as N311 as shown in FIG. 2A) used to stop the timer is fulfilled. The first threshold count may be less than the second threshold count. If the condition is fulfilled, the first apparatus 110 may consider that it has recovered from the radio problems at the start of the positioning measurement. In this case, the first apparatus 110 may stop the timer. Thus, new OoS evaluation, that is, the determination of the OoS counts, may be started after the measurement has finished. If the condition is unfulfilled, the first apparatus 110 may adjust the timer as described above.

In some example embodiment, the first apparatus 110 may adjust the timer based on a comparison of an actual measurement time with a measurement gap which may be network-configured. For example, the first apparatus 110 may determine a time length required to perform the positioning measurement process, for example, as the actual measurement time. Then, the first apparatus 110 may determine whether a condition that a time length is shorter than the length of the measurement gap is fulfilled. For example, a duration or a time length of the gap may be configured by the network, for example, via the second apparatus 120.

If this condition is fulfilled, the first apparatus 110 may consider that there is a margin of the configured measurement gap before or after the measurement process is finished. The first apparatus 110 may use such a margin for the RLF process. For example, the first apparatus 110 may postpone a start of the positioning measurement process until a stop of the timer or completion of the RLF process. If this condition is unfulfilled, the first apparatus 110 may adjust the timer as described above.

To further separate the RLF process and the positioning measurement process, in some example embodiments, the first apparatus 110 may consider a difference between the required time length and the measurement gap. For example, the first apparatus 110 may determine whether the required measurement time+offset<the measurement gap is fulfilled. The offset may be network-configured or UE-implemented. If it is fulfilled, which may mean that the required time is significantly shorter than the configured time, then the first apparatus 110 may attempt to complete the RLF process before starting the positioning measurement process. For example, the first apparatus 110 may continue counting the N311 IS indications for recovery, or continue the IS counting until an expiry of the timer such as T310.

In some example embodiments, the first apparatus 110 may determine whether a condition that a remaining time of the timer is less than a threshold time (referred to as a “first threshold time”) and a time until a start of the measurement gap is less than a further threshold time (referred to as a “second threshold time”) is fulfilled. The second threshold time is shorter than the first threshold time. If the condition is fulfilled, which may mean that it is likely to soon declare RLF and thus loose the RRC Connection, then the first apparatus 110 may continue the RLF process without an initiation of the positioning measurement process at the start of the measurement gap. If the condition is unfulfilled, the first apparatus 110 may adjust the timer as described above.

In some example embodiments, the first apparatus 110 may also consider an IS count to make a decision on such continuation of the RLF process. For example, the first apparatus 110 may compare an IS count, associated with the RLF process, and a threshold count (referred to as a third threshold count). The third threshold count may be set depending on the number of IS such as N311 for recovery. For example, the third threshold count may be much lower than N311. If the IS count is less than the third threshold count, which may mean that the first apparatus 110 may have counted much less IS and thus may declare the RLF, then the first apparatus 110 may continue the RLF process.

When the timer such as T310 is paused or extended or adjusted in other ways due to the measurement gap, the first apparatus 110 may not be able to perform the IS evaluation. Thus, in some example embodiments, the first apparatus 110 may adjust the IS evaluation associated with the RLF process, accordingly. For example, the IS evaluation may be paused during the positioning measurement process.

Alternatively, or in addition, a period of the IS evaluation may be extended to cover the length of the measurement gap. The extension may be performed based a configured value, which may correspond to the measurement gap duration or a scaling factor. In some example embodiments, this extension of the period may be network-configured. For example, the period may be extended based on a configuration (referred to as a “second configuration”) from a further apparatus (such as the second apparatus 120), which may be a network device or a terminal device, for an extension time (referred to as a “second extension time”) of the period. After the measurement gap is completed, the first apparatus 110 may fall back to the configured evaluation period which may be based on the T310 status and Discontinuous Reception (DRX) configuration, for example.

In some example embodiments, the first apparatus 110 may determine that the timer for the RLF process is non-started. In this case, the first apparatus 110 may determine an OoS count used to start the timer. If the OoS count is non-zero, the first apparatus 110 may reset the OoS count, or retain the OoS to be continued after the positioning measurement process. The resetting or retaining may also depend on whether the count exceeds a threshold larger than 0, but smaller than N310. As such, the start of the timer may be delayed, and thus the RLF process may not be collide with the positioning measurement.

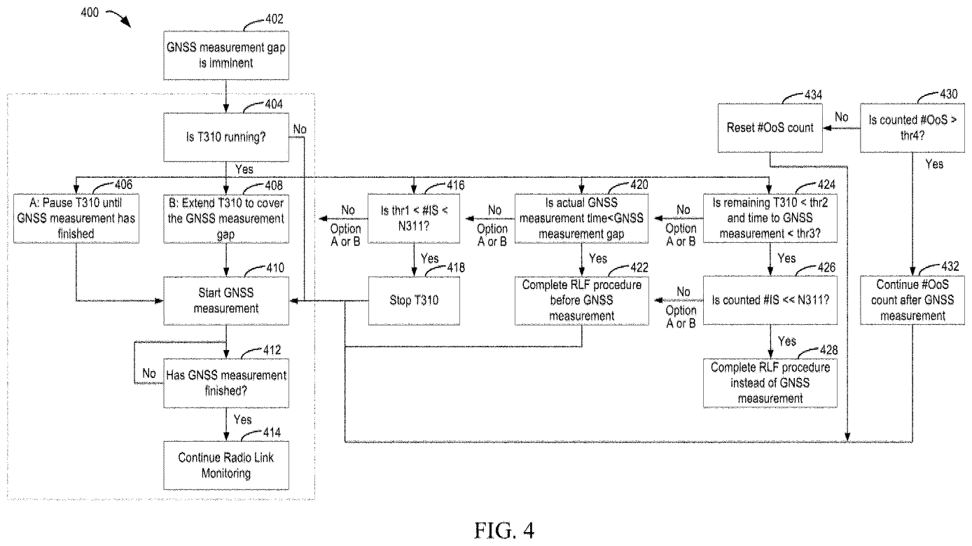

An example process for adjustment of the RLF process will be discussed below with reference to FIG. 4.

FIG. 4 shows a flow chart of an example process 400 at the first apparatus 110 to adjust the RLF process according to some example embodiments of the present disclosure. In this example, GNSS measurement may be performed by the first apparatus 110 as an example of the positioning measurement.

As shown in FIG. 4, at 402, the first apparatus 110 may determine that a GNSS measurement gap is imminent, for example, starting within x seconds. The GNSS measurement gap may be scheduled by the second apparatus 120, which may be a network device such as an eNB, or to be triggered autonomously by the first apparatus 110 which may be a terminal device as a UE. At 404, the first apparatus 110 may determine whether the timer such as T310 for the RLF process is running or not. If the T310 is running, the first apparatus 110 may adjust the T310 timer when the GNSS measurement gap starts, and stop IS evaluation.

The timer may be adjusted in two optional ways. Option A is shown at 406 where the T310 timer may be paused until the GNSS measurement has finished. For example, the first apparatus 110 may pause the T310 timer when the GNSS measurement gap starts and continue with the remainder of the T310 timer when the GNSS measurement is finished. Option B is shown at 408 where the T310 timer may be extended to cover the length of the GNSS measurement gap. For example, UE can extend the T310 when the GNSS measurement gap starts, such that the T310 timer may not expire during the GNSS measurement gap.

After the timer is adjusted, at 410, the first apparatus 110 may start the GNSS measurement. At 412, the first apparatus 110 may determine whether the GNSS measurement has finished. If yes, the first apparatus 110 may continue radio link monitoring (RLM). For example, the first apparatus 110 may continue to evaluate IS when the GNSS measurement has finished, according to the remainder of the T310 timer.

In an example embodiment, the first apparatus 110 may evaluate the number of IS and determine whether any IS has already been detected during T310. At 416, the first apparatus 110 may determine whether the number of IS is larger than the a (network-configured) threshold count, labeled as thr1, but smaller than a threshold count, such as N311, which would stop T310. If yes, the first apparatus 110 may consider it has recovered from the radio problems at the start of the GNSS measurement, and thus start new evaluation, for example, new counting of OoS after the GNSS measurement has finished. Then, at 418, the first apparatus 110 may stop T310, when the GNSS measurement is imminent. If no, option A or B may be implemented.

In an example embodiment, at 420, if the first apparatus 110 may determine whether the time required to perform the GNSS measurement is shorter than the configured GNSS measurement gap. If yes, at 422, the first apparatus 110 may attempt to complete the RLF procedure, such as count the N311 IS or wait for expiry of T310, before starting the GNSS measurement. If no, option A or B may be implemented.

In an example embodiment, at 424, the first apparatus 110 may determine whether the remaining time of T310 is below a (network-configured) a threshold time, labeled as thr2, and the time until start of the GNSS measurement gap is below a threshold time, labeled as thr3, where threshold2>threshold 3. If yes, the first apparatus 110 may continue the IS evaluation period instead of starting the GNSS measurement gap, because it is likely to soon declare RLF and thus loose the RRC Connection (for example, at 428).

The decision may also depend on the number of already counted IS if N311 is different from 1. As shown in FIG. 4, at 426, the first apparatus 110 may determine whether the counted number of IS, labeled as #IS, is much less than N311. If yes, at 428, the first apparatus 110 may complete the RLF procedure instead of GNSS measurement. For example, if the N311 is 10, but the first apparatus 110 has counted too less IS to declare the RLF, then the first apparatus 110 may make this decision.

In an example embodiment, if it is determined at 404 that T310 is not running, but the first apparatus 110 has counted a non-zero number of OoS, then the first apparatus 110 may continue the counting after the GNSS measurement gap or reset the count. This may also depend on whether the number of OoS is above or below a (network-configured) threshold. As shown FIG. 4, at 430, the first apparatus 110 may determine whether the counted number of OoS, labeled as #OoS, is above a threshold count, labeled as thr4. If yes, at 432, the first apparatus 110 may continue the #OoS count after the GNSS measurement. If no, at 434, the first apparatus 110 may reset the #OoS count. In an example, the first apparatus 110 may be configured to either keep the current OoS/IS counts and continue counting after the GNSS measurement gap or reset the OoS/IS counts upon completion of the GNSS measurement gap.

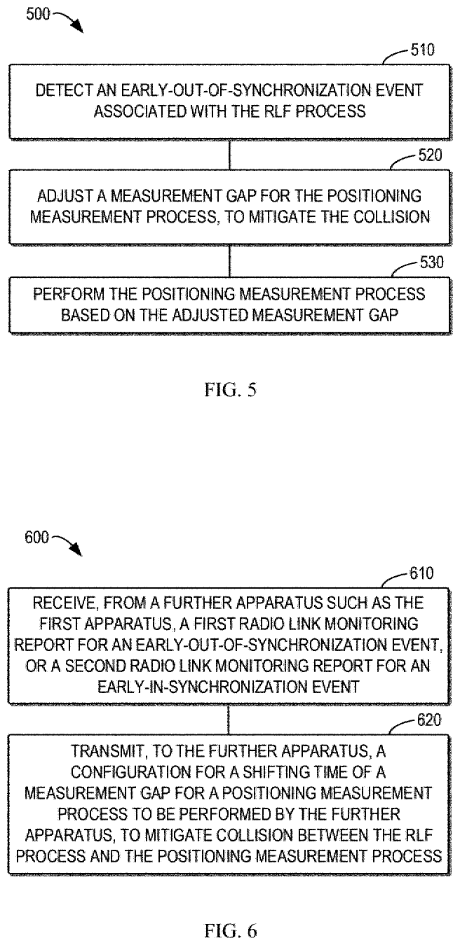

In addition to or instead of the RLF process, the first apparatus 110 may adjust the positioning measurement process to mitigate the collision between the two processes. In some example embodiments, the first apparatus 110 may adjust the measurement gap to mitigate the collision. Some example embodiments in this regard will be discussed below with reference to FIGS. 5 and 6.

FIG. 5 shows a flowchart of an example process 500 for adjusting a measurement gap in accordance with some example embodiments of the present disclosure. The process 500 may be implemented by the first apparatus 110. For the purpose of discussion, the process 500 will be described from the perspective of the first apparatus 110 in FIG. 1.

As shown in FIG. 5, at block 510, the first apparatus 110 may detect an early-out-of-synchronization (or “early-out-of-sync”) event associated with the RLF process.

At block 520, the first apparatus 110 may adjust a measurement gap for the positioning measurement process, to mitigate the collision. At block 530, the first apparatus 110 may perform the positioning measurement process based on the adjusted measurement gap.

In an example embodiment, the first apparatus 110 such as a UE may notify the network (for example, the second apparatus 120 such as a BS) about an imminent RLM event if the RLM report is configured. For example, if an “early-out-of-sync” event has been detected, the first apparatus 110 may initiate transmission of the UEAssistanceInformation message to report this event to the network. In this scenario, the first apparatus 110 and the network may be both aware of the “early-out-of-sync” event. Thus, the measurement gap, which may be configured by the network, may be adjusted to facilitate the RLF procedure.

The measurement gap may be adjusted in any suitable way. In some example embodiments, the measurement gap may be shifted or postponed bypassing the RLF process. The gap shift can be based on a previously configured value (for example, equal to a value of T310) or be indicated by the network, for example via the second apparatus 120, in response to the RLM report. In some example embodiments, the shift may be based on a configuration (referred to as a “third configuration”) from a further apparatus (such as the second apparatus 120), which may be a network device or a terminal device, for a shifting time of the measurement gap. In some example embodiments, the third configuration may be received by the first apparatus 110 after the first apparatus 110 transmits a RLM report (referred to as a “first RLM report”) for the “early-out-of-sync” event to the further apparatus upon the detection of this event.

In some example embodiments, the first apparatus 110 may adjust the measurement gap considering an early-in-synchronization (or “early-in-sync”) event, which may mean that the first apparatus 110 has almost recovered from the radio link problems. For example, the first apparatus 110 may consider a shift or postpone of the measurement gap after detection of an “early-in-sync” event associated with the RLF process.

The “early-in-sync” event may be also reported to the network. For example, if an “early-in-sync” event has been detected, the first apparatus 110 may initiate transmission of the UEAssistanceInformation message to report this event to the network. In some example embodiments, in response to the detection of the “early-in-sync” event, the first apparatus 110 may transmit, to a further apparatus (such as the second apparatus 120), which may be a network device or a terminal device, a RLM report (referred to as a second RLM report) for the “early-in-sync” event. Upon the transmission of the second RLM report, the first apparatus 110 may adjust the measurement gap.

FIG. 6 shows a flowchart of an example process 600 for adjusting a measurement gap in accordance with some other example embodiments of the present disclosure. The process 600 may be implemented by the second apparatus 120. For the purpose of discussion, the process 600 will be described from the perspective of the second apparatus 120 in FIG. 1.

As shown in FIG. 6, at block 610, the second apparatus 120 may receive, from a further apparatus such as the first apparatus, a first radio link monitoring report for an early-out-of-synchronization event, or a second radio link monitoring report for an early-in-synchronization event. The early-out-of-synchronization event and the early-in-synchronization event are associated with a RLF process performed by the further apparatus.

At block 620, the second apparatus 120 may transmit, to the further apparatus, a configuration for a shifting time of a measurement gap for a positioning measurement process to be performed by the further apparatus, to mitigate collision between the RLF process and the positioning measurement process.

All operations and features related to the second apparatus 120 and the network as described above with reference to FIGS. 3 to 5 are likewise applicable to the process 600 and have similar effects. For the purpose of simplification, the details will be omitted.

In some example embodiments, an apparatus capable of performing any of the method 300 and the process 500 (for example, the first apparatus 110 in FIG. 1) may comprise means for performing the respective operations of the method 300 and the process 500. The means may be implemented in any suitable form. For example, the means may be implemented in a circuitry or software module. The apparatus may be implemented as or included in the first apparatus 110 in FIG. 1.

In some example embodiments, the apparatus comprises means for performing a radio link failure process; and means for performing a positioning measurement process, wherein at least one of the radio link failure process or the positioning measurement process is adjusted to mitigate collision between the radio link failure process and the positioning measurement process.

In some example embodiments, means for performing the radio link failure process comprises: means for based on a determination that a measurement gap for the positioning measurement process is to start within a threshold time interval, determining whether a timer for the radio link failure process is running or non-started; means for based on a determination that the timer is running, adjusting the timer to mitigate the collision; and means for performing the radio link failure process based on the adjusted timer.

In some example embodiments, means for adjusting the timer comprises: means for pausing the timer during the positioning measurement process.

In some example embodiments, means for adjusting the timer comprises: means for extending the value of the timer to cover the length of the measurement gap.

In some example embodiments, the timer is extended based on a first configuration from a further apparatus for a first extension time of the timer.

In some example embodiments, means for adjusting the timer comprises: means for determining whether a condition that an in-synchronization count associated with the radio link failure process is equal to or greater than a first threshold count and less than a second threshold count used to stop the timer is fulfilled, the first threshold count being less than the second threshold count; and means for based on a determination that the condition is unfulfilled, adjusting the timer.

In some example embodiments, the apparatus further comprises: means for based on a determination that the condition is fulfilled, stopping the timer.

In some example embodiments, means for adjusting the timer comprises: means for determining a time length required to perform the positioning measurement process; means for determining whether a condition that the time length is shorter than the length of the measurement gap is fulfilled; means for based on a determination that the condition is unfulfilled, adjusting the timer.

In some example embodiments, the apparatus further comprises: means for based on a determination that the condition is fulfilled, postponing a start of the positioning measurement process until a stop of the timer or completion of the radio link failure process.

In some example embodiments, means for adjusting the timer comprises: means for determining whether a condition that a remaining time of the timer is less than a first threshold time and a time until a start of the measurement gap is less than a second threshold time is fulfilled, the second threshold time being shorter than the first threshold time; and means for based on a determination that the condition is unfulfilled, adjusting the timer.

In some example embodiments, the apparatus further comprises: means for based on a determination that the condition is fulfilled, continuing the radio link failure process without an initiation of the positioning measurement process at the start of the measurement gap.

In some example embodiments, means for continuing the radio link failure process comprises: means for comparing an in-synchronization count with a third threshold count, the in-synchronization count being associated with the radio link failure process, and the third threshold count being less than a second threshold count used to stop the timer; and means for based on a determination that the in-synchronization count is less than the third threshold count, continuing the radio link failure process.

In some example embodiments, the apparatus further comprises means for adjusting in-synchronization evaluation associated with the radio link failure process.

In some example embodiments, means for adjusting the in-synchronization evaluation comprises: means for pausing the in-synchronization evaluation during the positioning measurement process.

In some example embodiments, means for adjusting the in-synchronization evaluation comprises: means for extending a period of the in-synchronization evaluation to cover the length of the measurement gap.

In some example embodiments, the period of the in-synchronization evaluation is extended based on a second configuration from a further apparatus for a second extension time of the period.

In some example embodiments, the apparatus further comprises: means for based on a determination that the timer is non-started, determining an out-of-synchronization count used to start the timer; and means for based on a determination that the out-of-synchronization count is non-zero, resetting the out-of-synchronization count, or retaining the out-of-synchronization count to be continued after the positioning measurement process.

In some example embodiments, the resetting or the retaining is performed based on a determination that the out-of-synchronization count is equal to or less than a fourth threshold count.

In some example embodiments, means for performing the positioning measurement process comprises: means for after detection of an early-out-of-synchronization event associated with the radio link failure process, adjusting a measurement gap for the positioning measurement process, to mitigate the collision; and means for performing the positioning measurement process based on the adjusted measurement gap.

In some example embodiments, means for adjusting the measurement gap comprises: means for shifting or postponing the measurement gap.

In some example embodiments, the measurement gap is shifted based on a third configuration from a further apparatus for a shifting time of the measurement gap.

In some example embodiments, means for performing the positioning measurement process further comprises: means for in response to the detection of the early-out-of-synchronization event, transmitting, to the further apparatus, a first radio link monitoring report for the early-out-of-synchronization event, wherein the third configuration is received in response to transmitting the first radio link monitoring report.

In some example embodiments, means for adjusting the measurement gap comprises: means for after detection of an early-in-synchronization event associated with the radio link failure process, adjusting the measurement gap.

In some example embodiments, means for adjusting the measurement gap comprises: means for in response to the detection of the early-in-synchronization event, transmitting, to a further apparatus, a second radio link monitoring report for the early-in-synchronization event; and means for upon the transmission of the second radio link monitoring report, adjusting the measurement gap.

In some example embodiments, the apparatus further comprises means for performing other operations in some example embodiments of the method 300 or the process 500 or the first apparatus 110. In some example embodiments, the means comprises at least one processor; and at least one memory storing instructions that, when executed by the at least one processor, cause the performance of the apparatus.

In some example embodiments, an apparatus capable of performing any of the process 600 (for example, the second apparatus 120 in FIG. 1) may comprise means for performing the respective operations of the process 600. The means may be implemented in any suitable form. For example, the means may be implemented in a circuitry or software module. The apparatus may be implemented as or included in the second apparatus 120 in FIG. 1.

In some example embodiments, the apparatus comprises means for receiving, from a further apparatus, a first radio link monitoring report for an early-out-of-synchronization event, or a second radio link monitoring report for an early-in-synchronization event, the early-out-of-synchronization event and the early-in-synchronization event being associated with a radio link failure process performed by the further apparatus; and means for transmitting, to the further apparatus, a configuration for a shifting time of a measurement gap for a positioning measurement process to be performed by the further apparatus, to mitigate collision between the radio link failure process and the positioning measurement process.

In some example embodiments, the apparatus further comprises means for performing other operations in some example embodiments of the process 600 or the second apparatus 120. In some example embodiments, the means comprises at least one processor; and at least one memory storing instructions that, when executed by the at least one processor, cause the performance of the apparatus.

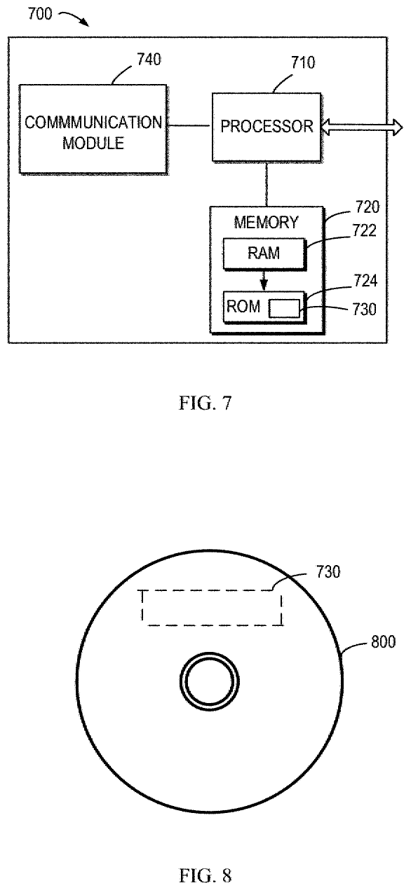

FIG. 7 is a simplified block diagram of an apparatus 700 that is suitable for implementing example embodiments of the present disclosure. The apparatus 700 may be provided to implement a communication device, for example, the first apparatus 110 or the second apparatus 120 as shown in FIG. 1. As shown, the apparatus 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The apparatus 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the apparatus 700 may perform any process of the disclosure as discussed with reference to FIG. 3 to FIG. 6. The example embodiments of the present disclosure may also be implemented by hardware or by a combination of software and hardware.

In some example embodiments, the program 730 may be tangibly contained in a computer readable medium which may be included in the apparatus 700 (such as in the memory 720) or other storage devices that are accessible by the apparatus 700. The apparatus 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments.

Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to perform:
performing a radio link failure process for a radio link failure declaration;
performing a positioning measurement process after starting a timer of the radio link failure process for the radio link failure declaration; and
extending or pausing, during the positioning measurement process, the timer of the radio link failure process for the radio link failure declaration.

2-25. (canceled)

26. A method comprising:
at an apparatus,
performing a radio link failure process for a radio link failure declaration;
performing a positioning measurement process after starting a timer of the radio link failure process for the radio link failure declaration; and
extending or pausing, during the positioning measurement process, the timer of the radio link failure process for the radio link failure declaration.

27-50. (canceled)

51. An apparatus comprising:
means for performing a radio link failure process for a radio link failure declaration;
means for performing a positioning measurement process after starting a timer of the radio link failure process for the radio link failure declaration; and,
means for extending or pausing, during the positioning measurement process, the timer of the radio link failure process for the radio link failure declaration.

52. (canceled)

53. (canceled)

54. A non-transitory computer readable medium comprising instructions stored thereon for causing an apparatus at least to perform a computer process comprising:
performing a radio link failure process for a radio link failure declaration;
performing a positioning measurement process after starting a timer of the radio link failure process for the radio link failure declaration, and
extending or pausing, during the positioning measurement process, the timer of the radio link failure process for the radio link failure declaration

55. The non-transitory computer readable medium of claim 54, wherein the instructions further cause the apparatus to pause the timer of the radio link failure process during the positioning measurement process.

56. The non-transitory computer readable medium of claim 55, wherein the instructions further cause the apparatus to continue the timer when the positioning measurement process is completed.

57. The non-transitory computer readable medium of claim 56, wherein the continuing the timer comprises continuing the timer with a remainder of a time of the timer.

58. The non-transitory computer readable medium of claim 57, wherein the instructions further cause the apparatus to pause the timer when or before a measurement gap for the positioning measurement process starts, and to continue the timer with the remainder of the time of the timer when the positioning measurement process is completed.

59. The non-transitory computer readable medium of claim 54, wherein the timer is paused to avoid a collision between the radio link failure process and the positioning measurement process.

60. The non-transitory computer readable medium of claim 54, wherein the positioning measurement process is a Global Navigation Satellite System, GNSS, measurement process.

61. The non-transitory computer readable medium of claim 54, wherein the timer is T310 timer.

62. The apparatus of claim 1, wherein the apparatus is caused to pause the timer of the radio link failure process during the positioning measurement process.

63. The apparatus of claim 62, wherein the apparatus is caused to perform:
continuing the timer when the positioning measurement process is completed.

64. The apparatus of claim 63, wherein the continuing the timer comprises continuing the timer with a remainder of a time of the timer.

65. The apparatus of claim 64, wherein the apparatus is caused to pause the timer when or before a measurement gap for the positioning measurement process starts, and to continue the timer with the remainder of the time of the timer when the positioning measurement process is completed.

66. The apparatus of claim 1, wherein the apparatus is caused to pause the timer to avoid a collision between the radio link failure process and the positioning measurement process.

67. The apparatus of claim 1, wherein the positioning measurement process is a Global Navigation Satellite System, GNSS, measurement process.

68. The apparatus of claim 1, wherein the timer is T310 timer.

69. The method of claim 26, wherein the apparatus pauses the timer of the radio link failure process during the positioning measurement process.

70. The method of claim 69, wherein the apparatus continues the timer when the positioning measurement process is completed.

71. The method of claim 70, wherein the continuing the timer comprises continuing the timer with a remainder of a time of the timer.

72. The method of claim 71, wherein the apparatus pauses the timer when or before a measurement gap for the positioning measurement process starts, and continues the timer with the remainder of the time of the timer when the positioning measurement process is completed.

73. The method of claim 26, wherein the timer is paused to avoid a collision between the radio link failure process and the positioning measurement process.

74. The method of claim 26, wherein the positioning measurement process is a Global Navigation Satellite System, GNSS, measurement process.

75. The method of claim 26, wherein the timer is T310 timer.
